(19) United States
(12) Patent Application Publication
(10) Pub. No.: US 2007/0133724 A1
(43) Pub. Date: Jun. 14, 2007

(54) Method and apparatus for time synchronization of devices within electrical power systems

(75) Inventors: Jeffrey Glenn Mazereeuw, Newmarket (CA); Bogdan Z. Kasztenny, Markham (CA)

Correspondence Address: PATRICK W. RASCHE (12552), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/299,426

(22) Filed: Dec. 12, 2005

(51) Int. Cl. H04L 7/00

(52) U.S. Cl. 375/354

(57) ABSTRACT

A method for distributing a timing signal to a device. The method includes receiving a timing signal from a timing source, receiving a power signal, superimposing the timing signal on the power signal to facilitate creating a different power signal to be distributed to the device, decoding the timing signal from the power signal within the device, and adjusting an internal clock of the device to facilitate synchronizing the internal clock with the decoded timing signal.

### BACKGROUND OF THE INVENTION

This invention relates generally to electrical power systems, and more specifically to methods and apparatus for time synchronization of devices within electrical powers systems.

At least some known electrical power systems are spread over geographical areas spanning from power generation stations, through voltage transmission facilities, to voltage distribution networks and electrical loads. Components of such electrical power systems may be monitored, for example, to protect assets, for example disconnecting an asset in case of an internal failure or operating conditions that may jeopardize the asset, may be monitored for overall system protection, for example disconnecting loads and/or generators to protect an integrity of the electrical power system, and/or may be monitored for general control of the electrical power system, for example adjusting operating parameters and/or conditions of the system. Furthermore, components of such known electrical power systems may be monitored to record operating parameters and/or conditions of the system, for example to generate a time record of system parameters for post-mortem analysis, and/or may be monitored for metering, for example measuring parameters and/or operating conditions of the system for operation and/or revenue. Moreover, components of such known electrical power systems may be monitored to measure, store, and/or alarm with respect to operating parameters and/or conditions of the system.

Devices used to monitor known electrical power systems may include a processor, and are sometimes referred to as Intelligent Electronic Devices (IEDs). However, to facilitate monitoring of the electrical power system, at least some known IEDs may need to be synchronized with respect to time. One known level of synchronization is wherein one or more devices act as a master for other devices to synchronize to. More specifically, devices are not synchronized to a universal external time base. Another level of synchronization is an explicit time synchronization of a number of devices to a common time reference, for example Corrected Universal Time (UTC). A universal external time base may be used across geographically distributed areas, for example between devices in the same substation or facility, between various substations of a given electric utility, between utilities, and/or between power system interconnections.

At least one known method of time synchronization includes using an internal clock in each device that is manually synchronized every few days or so. However, some known internal clocks that are synchronized every few days or so may be less accurate than is sometimes desired because of limited synchronization accuracy and/or drift of the internal clock between two consecutive synchronization instances. For example, some known internal clocks may only provide time synchronization at the level of a few seconds or minutes. At least some known voltage level may require more precise synchronization than the level of a few seconds or minutes. For example, synchronization error below about ten microseconds is sometimes desired for some known voltage levels. Synchronization error below about ten microseconds is sometimes achieved by synchronizing an internal clock of each device with an external time signal received from an external time generator, for example a Global Positioning System (GPS)—driven clock. The time signals are sometimes distributed to the devices using metallic and/or fiber-optic distribution networks. However, such a synchronization method may require at least one time generator per facility as well as other infrastructure, for example amplifiers, signal converters, signal repeaters, and/or wiring, to distribute the timing signals to each device, thereby possibly increasing a cost and/or decreasing a reliability of the time synchronization system.

### BRIEF DESCRIPTION OF THE INVENTION

In one aspect, a method is provided for distributing a timing signal to a device. The method includes receiving a timing signal from a timing source, receiving a power signal, superimposing the timing signal on the power signal to facilitate creating a different power signal to be distributed to the device, decoding the timing signal from the power signal within the device, and adjusting an internal clock of the device to facilitate synchronizing the internal clock with the decoded timing signal.

In another aspect, a method is provided for receiving timing information from at least one of a radio source and a satellite source with a device. The method includes receiving an electromagnetic wave signal that includes the timing information, decoding the timing information from the received signal within the device, and adjusting an internal clock of the device to facilitate synchronizing the internal clock with the decoded timing information.

In another aspect, a system includes a power source, a timing source, and merging circuitry operatively connected to the power source to receive a power signal therefrom and operatively connected to the timing source to receive a timing signal therefrom. The merging circuitry is configured to superimpose the timing signal onto the power signal. The system also includes at least one device operatively connected to the merging circuitry to receive the power signal that includes the superimposed timing signal from the merging circuitry. The at least one device is configured to decode the timing signal from the power signal and adjust an internal clock of the at least one device based on the decoded timing signal to facilitate synchronizing the internal clock with the decoded timing signal.

In another aspect, a device operatively connectable to a power source to receive a power signal therefrom is provided. The device includes an antenna for receiving an electromagnetic wave signal that includes timing information from a timing source. The device is configured to decode the timing information from the electromagnetic wave signal and adjust an internal clock of the device based on the decoded timing signal to facilitate synchronizing the internal clock with the decoded timing signal.

### BRIEF DESCRIPTION OF THE DRAWINGS

FIG. 1 is a schematic block diagram of an exemplary embodiment of a electrical power system.

FIG. 2 is a schematic block diagram of a portion of the electrical power system shown in FIG. 1 illustrating an exemplary embodiment of merging circuitry of the electrical power system shown in FIG. 1.

FIG. 3 is a schematic block diagram of another exemplary embodiment of a electrical power system.

### DETAILED DESCRIPTION OF THE INVENTION

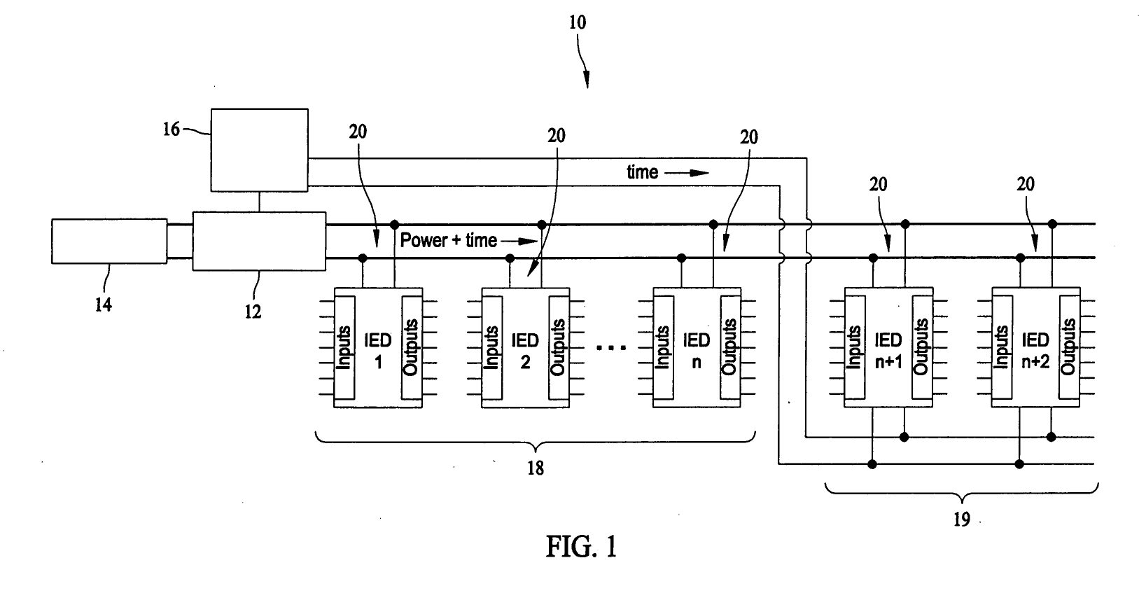

FIG. 1 is a schematic block diagram of an exemplary embodiment of an electrical power monitoring, control, and protection system 10. System 10 includes a power source 14, merging circuitry 12, a timing source 16, and a plurality of devices 18 and 19. Power source 14 may be any suitable power source providing any suitable type of electrical power. In some embodiments, power source 14 derives alternating current (AC) from a primary circuit (not shown, e.g., power lines). However, in the exemplary embodiment, power source 14 includes one or more batteries (not shown) for providing direct current (DC). As such, appropriate redundancy may be maintained by separation of some components of system 10 from the primary AC circuit. Although power source 14 may provide direct current at any suitable voltage, in some embodiments, power source 14 provides DC voltage from the batteries at between about 100 volts and about 250 volts. Although any suitable structure and/or means may be used, in the exemplary embodiment, and for example, electrical power from power source 14 is distributed to devices 18 and 19 via 2-wire DC connections 20. In the exemplary embodiment, connections 20 are ungrounded, or more specifically neither the positive nor the negative pole of system 10 is grounded. Such ungrounded connections 20 may facilitate delivering DC power even if one of wire of a connection 20 is grounded due to a short circuit in system 10.

Devices 18 and 19 may be any suitable device, such as, but not limited to, any protection, control, monitoring, metering, and/or recording device, such as, but not limited to, protective relays, programmable logic controllers, meters, sequence of event recorders, digital fault recorders, diagnostic devices, and/or monitoring devices. In the exemplary embodiment, devices 18 and 19 are Intelligent Electronic Devices (IEDs).

Timing source 16 may be any suitable timing source that is capable of performing the functions described herein. Timing source 16 may receive a signal containing timing information, sometimes referred to herein as a timing signal, from an external source (not shown), for example via a standard signal format, a proprietary signal format, and/or a synchronization method. Moreover, and for example, in some embodiments the timing source may receive a signal provided via a dedicated signal and/or a packet-based synchronization mechanism. In other embodiments, timing source 16 may generate the timing signal internally based on a radio and/or satellite signal, such as, but not limited to a publicly available radio signal, a publicly available satellite signal, an atomic clock signal, a weather radio signal, a specialized terrestrial timing wave, and/or a cellular phone signal.

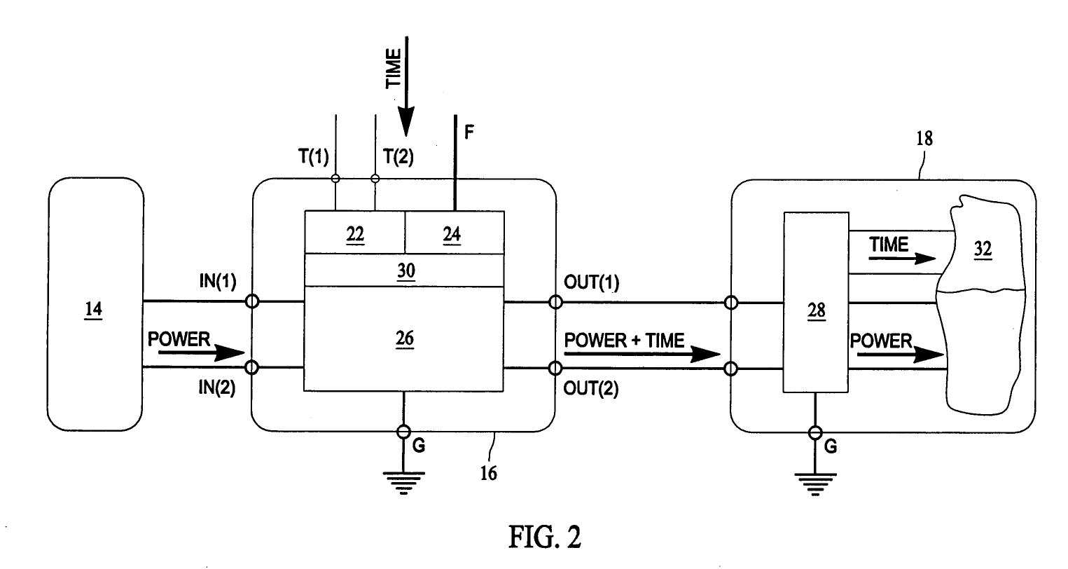

Merging circuitry 12 is operatively coupled to power source 14 and timing source 16 for superimposing a timing signal received from timing source 16 onto a power signal received from power source 14. FIG. 2 is a schematic block diagram of a portion of system 10 illustrating an exemplary embodiment of merging circuitry 12. Although merging circuitry 16 may receive the timing signal from timing source 16 using any suitable mechanism, method, process, signal, standard, structure and/or means, in some embodiments, and for example, merging circuitry 12 receives the timing signal using a metallic connection 22 and/or a fiber connection 24. Moreover, although merging circuitry 12 may receive the timing signal from timing source 16 using any suitable mechanism, method, process, signal, standard, structure and/or means, in some embodiments, and for example, merging circuitry 12 receives the timing signal using network-communications mechanisms, such as, but not limited to, Network Transfer Protocol (NTP), Simple Network Transfer Protocol (SNTP), and/or other standard and/or proprietary protocols.

Merging circuitry 12 superimposes the timing signal received from timing source 16 onto the power signal received from power source 14, using any suitable modulation technique, to facilitate creating a different power signal that includes the timing signal. Merging circuitry 12 includes a coupling circuit 26 that communicates with a coupling circuit 28 in devices 18 to deliver the power signal that includes the timing signal to devices 18. In some embodiments, merging circuitry 12 includes an isolation circuit 30 that facilitates isolating components of system 10. For example, in some embodiments isolation circuit 30 monitors system 10 and the dc voltage of power source 14 for short circuits with ground that may damage components of system 10.

In the exemplary embodiment, system 10 includes one or more of devices 19, which do not receive timing signals superimposed onto the power signal, but rather are operatively connected directly to timing source 16 to receive the timing signal directly from timing source 16, similar to known methods. In some embodiments, some or all of devices 19 may not be operatively connected to timing source 16 and/or may not receive a timing signal from timing source 16. In some embodiments, merging circuitry 12 superimposes the timing signal onto the power signal in such a way that facilitates a superimposing a timing signal of a low enough energy such that the superimposed timing signal may not degrade the power signal, and therefore may not interfere with operation of devices 19, which may not expect and/or recognize the timing information in the power signal. Moreover, in some embodiments merging circuitry 12 superimposes the timing signal onto the power signal in such a way that facilitates superimposing a timing signal that may be at least partially immune to transients in system 10, such as, but not limited to, breakers (not shown) and/or short-circuits. Furthermore, in some embodiments merging circuitry 12 superimposes the timing signal onto the power signal in such a way that facilitates superimposing a timing signal that may not interfere with ground monitoring systems (not shown) and/or may not interfere with breaker monitoring systems (not shown).

Devices 18 receive the power signal that includes the superimposed timing signal and decode the timing signal from the power signal. More specifically, devices 18 separate the timing signal from the power signal. Devices 18 then adjust an internal clock 32 thereof based on the timing signal to facilitate synchronizing internal clock 32 with the decoded timing signal. As such, the timing signal is distributed to devices 18 without a dedicated connection, but rather using the existing power supply connections 20. Accordingly, system 10 may facilitate reducing an overall cost of timing synchronization as well as may facilitate increasing a reliability of timing synchronization. In some embodiments, time synchronization is performed by devices 18 within seconds or tens of seconds. Moreover, in some embodiments devices 18 may skip synchronization for several seconds if devices 18 include ride-through capabilities. Furthermore, in some embodiments, the timing signal may be checked for consistency and/or errors, which may be detected and/or rejected. In some embodiments, system 10 may facilitate of accuracy of time synchronization in a range of microseconds. Moreover, in some embodiments a reduction or elimination of cabling and the associated capacitances, for example due to proximity of devices 18 to power source 14, may facilitate improving an accuracy of the time synchronization.

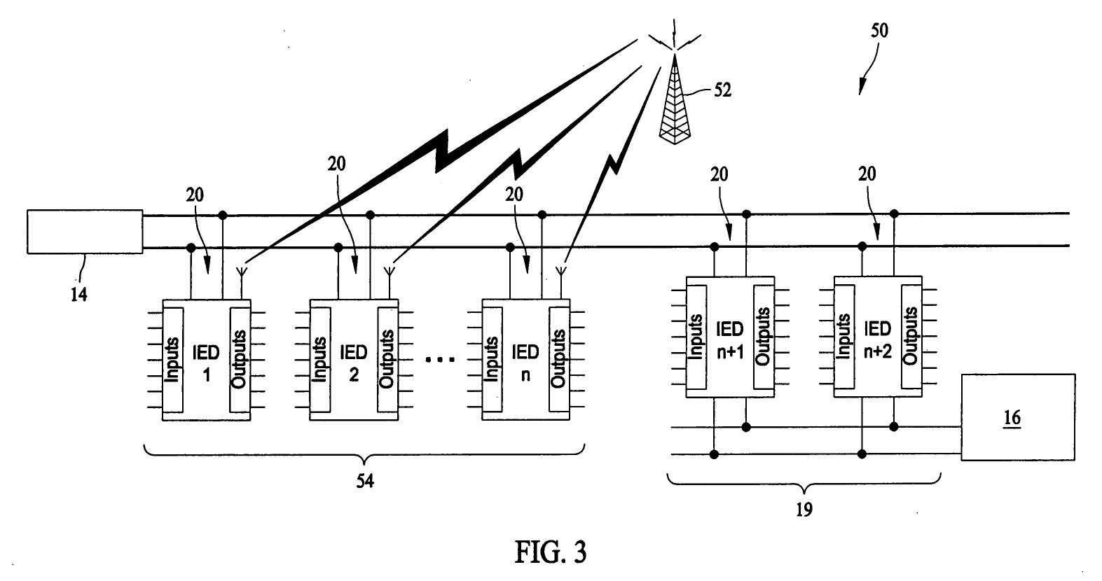

FIG. 3 is a schematic block diagram of another exemplary embodiment of an electrical power monitoring, control, and protection system 50. Components of system 50 that are identical to components of system 10 will be identified with the same reference numerals as in system 10. System 50 includes power source 14, a timing source 52, and a plurality of devices 54 and 19. Timing source 52 transmits an electromagnetic wave signal that includes timing information. Timing source 52 may be any suitable timing source that is capable of performing the functions described herein. Timing source 52 may transmit any electromagnetic wave signal, such as, but not limited to a radio and/or satellite signal. For example, although timing source 52 may transmit other electromagnetic signals, in some embodiments timing source 52 transmits a publicly available radio signal, a publicly available satellite signal, an atomic clock signal, a weather radio signal, a specialized terrestrial timing wave, and/or a cellular phone signal. In some embodiments, timing source 52 may transmit a dedicated signal.

Devices 54 and 19 may be any suitable device, such as, but not limited to, any protection, control, monitoring, metering, and/or recording device, such as, but not limited to, protective relays, programmable logic controllers, meters, sequence of event recorders, digital fault recorders, diagnostic devices, and/or monitoring devices. In the exemplary embodiment, devices 54 and 19 are Intelligent Electronic Devices (IEDs). Moreover, devices 54 each include an antenna for receiving the electromagnetic wave signal transmitted by timing source 52.

In the exemplary embodiment, system 50 includes one or more of devices 19, which do not receive the electromagnetic wave signal transmitted by timing source 52, but rather are operatively connected directly to timing source 16 to receive a timing signal directly from timing source 16, similar to known methods. In some embodiments, some or all of devices 19 may not be operatively connected to timing source and/or may not receive a timing signal from timing source 16.

Devices 54 receive the electromagnetic wave signal that includes the timing information and decode the timing information from the electromagnetic wave signal. Devices 54 then adjust an internal clock (not shown) thereof based on the timing information to facilitate synchronizing the internal clock with the decoded timing information. As such, the timing signal may be distributed to devices 54 without a dedicated connection, but rather using the electromagnetic wave signal transmitted by timing source 52. Accordingly, system 50 may facilitate reducing an overall cost of timing synchronization as well as may facilitate increasing a reliability of timing synchronization. In some embodiments, time synchronization is performed by devices 54 within seconds or tens of seconds. Moreover, in some embodiments devices 54 may skip synchronization for several seconds if devices 54 include ride-through capabilities. Furthermore, in some embodiments, the timing signal may be checked for consistency and/or errors, which may be detected and/or rejected.

In some embodiments, system 50 includes a plurality of timing sources 52 that each transmit an electromagnetic wave signal. Each of the signals may be averaged, monitored, amplified, and/or responded to by system 50. Moreover, in some embodiments, one or more of the timing sources 52 may be automatically selected by system 50 and/or may be pre-selected based on a reception of each of the signals and/or an accuracy of the timing information of each of the signals. In some embodiments, system 50 may facilitate of accuracy of time synchronization in a range of microseconds.

Exemplary embodiments of systems and methods are described and/or illustrated herein in detail. The systems and methods are not limited to the specific embodiments described herein, but rather, components of each system, as well as steps of each method, may be utilized independently and separately from other components and steps described herein. Each component, and each method step, can also be used in combination with other components and/or method steps. For example, portions or all of the timing synchronization methods of systems 10 and 50 may be combined, for example to provide a primary and a backup mode of timing synchronization. Portions or all of the timing synchronization methods of systems 10 and/or 50 may also be combined with known timing synchronization methods.

When introducing elements/components/etc. of the systems and methods described and/or illustrated herein, the articles “a”, “an”, “the” and “said” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc.

While the invention has been described in terms of various specific embodiments, those skilled in the art will recognize that the invention can be practiced with modification within the spirit and scope of the claims.

What is claimed is:

1. A method for distributing a timing signal to a device, said method comprising:
receiving a timing signal from a timing source;
receiving a power signal;
superimposing the timing signal on the power signal to facilitate creating a different power signal to be distributed to the device;
decoding the timing signal from the power signal within the device; and
adjusting an internal clock of the device to facilitate synchronizing the internal clock with the decoded timing signal.

2. A method in accordance with claim 1 wherein receiving a timing signal further comprises receiving a timing signal provided from an external source via one of a standard signal format, a proprietary signal format, and a synchronization method.

3. A method in accordance with claim 2 wherein receiving a timing signal provided from an external source further comprises receiving a timing signal provided via at least one of a dedicated signal and a packet-based synchronization mechanism.

4. A method in accordance with claim 1 wherein receiving a timing signal provided from an external source further comprises receiving a timing signal using at least one of a metallic and a fiber connection.

5. A method in accordance with claim 1 further comprising generating the timing signal internally from at least one of a publicly available radio signal and a publicly available satellite signal.

6. A method in accordance with claim 5 wherein generating the timing signal internally from at least one of a publicly available radio signal and a publicly available satellite signal further comprises generating the timing signal based on at least one of an atomic clock signal, a weather radio signal, a specialized terrestrial timing wave, and a cellular phone signal.

7. A method in accordance with claim 1 wherein receiving a power signal further comprises receiving one of a direct current power signal and an alternating current power signal.

8. A method in accordance with claim 1 wherein decoding the timing signal from the power signal within the device further comprises separating the timing signal from the power signal using the device.

9. A method in accordance with claim 1 wherein adjusting an internal clock of the device comprises adjusting the internal clock using the device.

10. A method in accordance with claim 1 wherein superimposing the timing signal further comprises superimposing the timing signal on the power signal to facilitate creating a different power signal to be distributed to an Intelligent Electronic Device (IED), wherein decoding the timing signal from the power signal further comprises decoding the timing signal from the power signal in the IED, and wherein adjusting an internal clock of the device further comprises adjusting an internal clock of the IED to facilitate synchronizing the internal clock with the decoded timing signal.

11. A method for receiving timing information from at least one of a radio source and a satellite source with a device, said method comprising:
receiving an electromagnetic wave signal that includes the timing information;
decoding the timing information from the received signal within the device; and
adjusting an internal clock of the device to facilitate synchronizing the internal clock with the decoded timing information.

12. A method in accordance with claim 11 wherein receiving an electromagnetic wave signal that includes the timing information further comprises receiving at least one of a publicly available radio signal, a publicly available satellite signal, an atomic clock signal, a weather radio signal, a terrestrial timing wave, and a cellular phone signal.

13. A method in accordance with claim 11 further comprising one of automatically selecting and pre-selecting the at least one of a radio source and a satellite source based on at least one of a reception of the signal and an accuracy of the timing information.

14. A method in accordance with claim 11 wherein receiving an electromagnetic wave signal further comprises receiving a plurality of electromagnetic wave signals.

15. A method in accordance with claim 14 further comprising at least one of averaging, monitoring, and responding to at least one of the received plurality of electromagnetic wave signals.

16. A method in accordance with claim 11 further comprising amplifying the received electromagnetic wave signal.

17. A method in accordance with claim 11 wherein receiving an electromagnetic wave signal further comprises receiving a signal provided via a dedicated signal.

18. A method in accordance with claim 11 wherein decoding the timing information from the received signal within the device further comprises decoding the timing information within an Intelligent Electronic Device (IED, and wherein adjusting an internal clock of the device further comprises adjusting an internal clock of the IED to synchronize the internal clock with the decoded timing information.

19. A system comprising:
a power source;
a timing source;
merging circuitry operatively connected to said power source to receive a power signal therefrom and operatively connected to said timing source to receive a timing signal therefrom, said merging circuitry configured to superimpose the timing signal onto the power signal; and
at least one device operatively connected to said merging circuitry to receive the power signal that includes the superimposed timing signal from said merging circuitry, said at least one device configured to decode the timing signal from the power signal and adjust an internal clock of said at least one device based on the decoded timing signal to facilitate synchronizing said internal clock with the decoded timing signal.

20. A system in accordance with claim 19 wherein said at least one device comprises at least one of a protective relay, a programmable logic controller, a meters, a sequence of event recorder, a digital fault recorder, a diagnostic device, and a monitoring devices.

21. A device operatively connectable to a power source to receive a power signal therefrom, said comprising an antenna for receiving an electromagnetic wave signal that includes timing information from a timing source, said device configured to decode the timing information from the electromagnetic wave signal and adjust an internal clock of said device based on the decoded timing signal to facilitate synchronizing said internal clock with the decoded timing signal.

22. A device in accordance with claim 21 wherein said at least one device comprises at least one of a protective relay, a programmable logic controller, a meters, a sequence of event recorder, a digital fault recorder, a diagnostic device, and a monitoring devices.
